(19) United States
(12) Patent Application Publication
(10) Pub. No.: US 2009/0304293 A1
(43) Pub. Date: Dec. 10, 2009

(54) MOTION ESTIMATION METHOD AND RELATED APPARATUS FOR EFFICIENTLY SELECTING MOTION VECTOR

(76) Inventors: Te-Hao Chang, Taipei City (TW); Siou-Shen Lin, Taipei County (TW); Chin-Chuan Liang, Taichung City (TW)

Correspondence Address: NORTH AMERICA INTELLECTUAL PROPERTY CORPORATION, P.O. BOX 506, MERRIFIELD, VA, 22116, US

(21) Appl. No.: 12/135,200

(22) Filed: Jun. 8, 2008

(51) Int. Cl. H04N 7/26

(52) U.S. Cl. 382/236; 375/240.16

(57) ABSTRACT

A motion estimation method includes selecting a plurality of selected motion vectors from a plurality of candidate motion vectors according to dissimilarity/priorities of the candidate motion vectors and determining a target motion vector corresponding to a minimum block matching cost according to the selected motion vectors without referring to each non-selected motion vector remaining in the candidate motion vectors.

### BACKGROUND

The present invention relates to a motion estimation scheme, and more particularly, to a motion estimation method for determining a target motion vector according to dissimilarity/priorities of candidate motion vectors and an apparatus thereof.

In general, there are many conventional motion estimation schemes proposed in published papers or books for determining target motion vector(s). In order to search for a target motion vector from a group of candidate motion vectors, a full search algorithm, a three-step search algorithm, and a three-dimensional recursive search (3DRS) algorithm are general method to be utilized. For a current image block, the full search algorithm is utilized for searching for an image block (in a previous/current frame) among all candidate image blocks within a search range, where a difference between this image block and the current image block is a minimum. In other words, the full search algorithm selects a target motion vector among all candidate motion vectors corresponding to the candidate image blocks within the search range. This target motion vector is associated with the found image block and is used as a reference vector when performing video encoding or motion compensation.

The three-step search algorithm searches for an image block at candidate image blocks by using search ranges of different sizes. Please refer to FIG. 1. FIG. 1 shows an example of searching for an image block by using the three-step search algorithm. The three-step search algorithm first finds an image block MB₁ among eight possible image blocks MB₁-MB₈ within a predetermined search range R₁, where the difference between the image block MB₁ and a current image block MB is a minimum (compared with differences between the respective possible image blocks and the current image block MB). Then, the three-step search algorithm finds an image block MB₄′ among eight possible image blocks MB₁′-MB₈′ within a smaller predetermined range R₂; these possible image blocks MB₁′-MB₈′ surround the image block MB₁. The difference between the image block MB₄′ and the current image block MB is a minimum compared with the differences between the respective possible image blocks and the current image block MB. Next, the three-step search algorithm finds an image block MB₂″ among eight possible image blocks MB₁″-MB₃″, MB₂, and MB₅″-MB₈″ within a smallest predetermined range R₃, where the image block MB₄′ is surrounded with the image blocks MB₁″-MB₃″, MB₂, and MB₅″-MB₈″. The difference between the image block MB₂″ and current image block MB is a minimum. Consequently, this search algorithm selects a target motion vector corresponding to this image block MB₂″ as a reference vector of the current image block MB when video encoding/tracking is performed.

Additionally, for a current image block, the above-mentioned 3DRS algorithm is utilized for searching for a target motion vector among found target motion vectors of neighboring image blocks and at least one random generated motion vector. In other words, for the 3DRS algorithm, candidate motion vectors are usually the found target motion vectors of the neighboring image blocks and randomly generated motion vector(s).

In general, the computation resources required by the full search algorithm are much greater than those required by the three-step search algorithm and 3DRS algorithm. Usually, computation resources required by the three-step search algorithm are also greater than those required by the 3DRS algorithm. The 3DRS algorithm needs the least computation resources for determining a target motion vector. If the computation resources (e.g. memory bandwidth or the battery) are insufficient, however, there is still a high possibility for the 3DRS algorithm that block matching differences corresponding to the above-mentioned candidate motion vectors cannot be completely calculated. That is, in this situation, the 3DRS algorithm may be interrupted and an undesired motion vector may be selected as a reference vector, so motion estimation will operate inaccurately. This problem will become more serious when the 3DRS algorithm is applied to mobile devices.

### SUMMARY

Therefore, one of the objectives of the present invention is to provide a motion estimation method for efficiently selecting a target motion vector according to computation resources and apparatus utilized, to solve the above-mentioned problem.

According to a first embodiment of the present invention, a motion estimation method is disclosed. The motion estimation method comprises selecting a plurality of first selected motion vectors from a plurality of candidate motion vectors according to dissimilarity of the candidate motion vectors and determining a target motion vector corresponding to a minimum block matching cost according to the first selected motion vectors without referring to each non-selected motion vector remaining in the candidate motion vectors.

According to the first embodiment of the present invention, a motion estimation apparatus is disclosed. The motion estimation apparatus comprises a first selection unit and a decision device. The first selection unit is utilized for selecting a plurality of first selected motion vectors from a plurality of candidate motion vectors according to dissimilarity of the candidate motion vectors, and the decision device is coupled to the first selection unit and utilized for determining a target motion vector corresponding to a minimum block matching cost according to the first selected motion vectors without referring to each non-selected motion vector remaining in the candidate motion vectors.

According to a second embodiment of the present invention, a motion estimation method is disclosed. The motion estimation method comprises selecting a plurality of selected motion vectors from a plurality of candidate motion vectors according to priorities of the candidate motion vectors and determining a target motion vector corresponding to a minimum block matching cost according to the selected motion vectors without referring to each non-selected motion vector remaining in the candidate motion vectors.

According to the second embodiment of the present invention, a motion estimation apparatus is disclosed. The motion estimation apparatus comprises a selection unit and a decision device. The selection unit is utilized for selecting a plurality of selected motion vectors from a plurality of candidate motion vectors according to priorities of the candidate motion vectors, and the decision device is coupled to the selection unit and utilized for determining a target motion vector corresponding to a minimum block matching cost according to the selected motion vectors without referring to each non-selected motion vector remaining in the candidate motion vectors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an example of searching for an image block by using a three-step search algorithm.

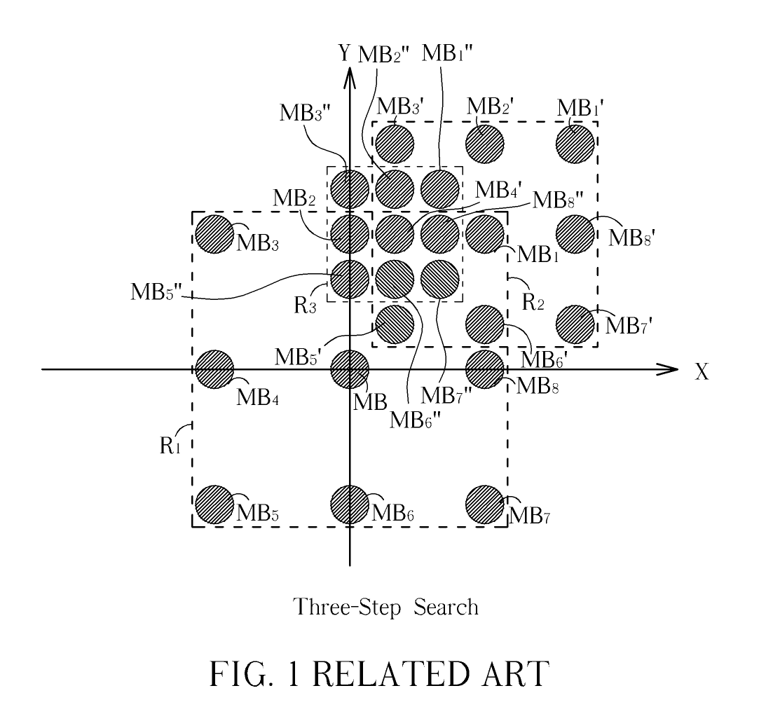

FIG. 2 is a block diagram of a motion estimation apparatus according to a first embodiment of the present invention.

FIG. 3 is a diagram showing an example of determining a target motion vector by using the motion estimation apparatus shown in FIG. 2.

FIG. 4 is a block diagram illustrating a motion estimation apparatus according to a second embodiment of the present invention.

FIG. 5 is a flowchart of the motion estimation apparatus shown in FIG. 2.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

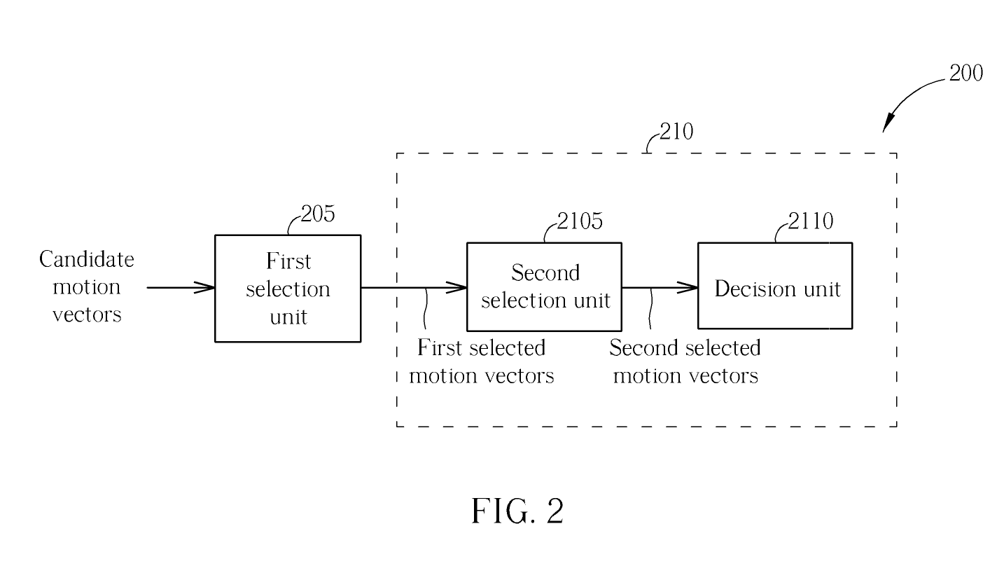

Please refer to FIG. 2. FIG. 2 is a block diagram of a motion estimation apparatus 200 according to a first embodiment of the present invention. As shown in FIG. 2, the motion estimation apparatus 200 comprises a first selection unit 205 and a decision device 210. The first selection unit 205 is utilized for selecting a plurality of first selected motion vectors from a plurality of candidate motion vectors according to dissimilarity of the candidate motion vectors. The decision device 210 is coupled to the first selection unit 205, and utilized for determining a target motion vector corresponding to a minimum block matching cost according to the first selected motion vectors without referring to each non-selected motion vector remaining in the candidate motion vectors. In general, the matching cost is referred to the matching cost function, such as Sum of absolute difference (SAD), mean square error, matching difference function, or other matching cost functions known in the relevant art. Because the first selected motion vectors are dissimilar to each other and each non-selected motion vector is similar/equivalent to one of the first selected motion vectors, the decision device 210 only needs to refer to the first selected motion vectors for determining the target motion vector. A rule for selecting the first selected motion vectors is described in the following. When each vector difference between every two of a plurality of first motion vectors in the candidate motion vectors is less than a threshold value, the first motion vectors are regarded as similar/equivalent vectors. The first selection unit 205 selects one of the first motion vectors as a first selected motion vector. Of course, the first selection unit 205 can also choose at least two of the first motion vectors as first selected motion vectors, where the number of vectors chosen by the first selection unit 205 should be smaller than that of the first motion vectors. This also eases the occupancy of most computation resources. As mentioned above, by using the first selection unit 205 to choose dissimilar motion vectors, the motion estimation apparatus 200 can reduce computation costs.

In addition, the decision device 210 comprises a second selection unit 21 05 and a decision unit 2110. The second selection unit 2105 selects a plurality of second selected motion vectors from the first selected motion vectors according to priorities of the first selected motion vectors; the decision unit 2110 then determines the target motion vector corresponding to the minimum block matching cost according to the second selected motion vectors, without referring to each non-selected motion vector remaining in the first selected motion vectors. A number of the second selected motion vectors is determined according to computation resources. As described above, since priorities of the second motion vectors chosen by the second selection unit 2105 are much higher than that of each non-selected motion vector remaining in the first selected motion vectors, the decision unit 2110 only refers to the second selected motion vectors for determining the target motion vector in order to decrease computation costs. In other words, by using the second selection unit 21 05 to choose the second selected motion vectors from the first selected motion vectors, the motion estimation apparatus 200 can reduce the computation costs further.

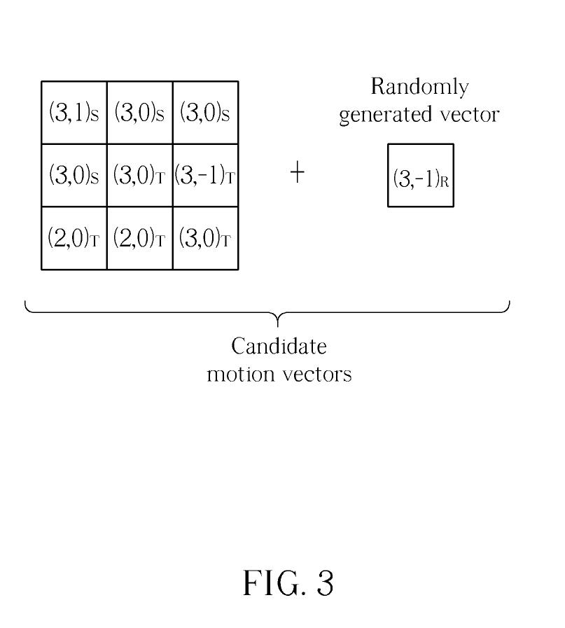

An example of determining a target motion vector using the motion estimation apparatus 200 is detailed herein, and shown in FIG. 3. It is assumed that candidate motion vectors are determined according to a three-dimensional recursive search (3DRS) algorithm. In this example, the candidate motion vectors consist of a randomly generated motion vector and nine determined motion vectors that respectively correspond to image blocks of FIG. 3; for convenience, the determined motion vectors are shown on respective image blocks of FIG. 3. That is, the candidate motion vectors comprise spatial motion vectors (3,1)_{S}, (3,0)_{S}, (3,0)_{S}, and (3,0)_{S}, temporal motion vectors (3,0)_{T}, (3,-1)_{T}, (2,0)_{T}, (2,0)_{T}, and (3,0)_{T}, and the randomly generated motion vector (3,-1)_{R}. As mentioned above, through the first selection unit 205, the first selected motion vectors will be (3,1)_{S}, (3,0)_{S}, (3,-1)_{R}, and (2,0)_{T}. This is because motion vectors which are similar/equivalent to the first selected motion vectors (3,1)_{S}, (3,0)_{S}, (3,-1)_{R}, and (2,0)_{T} are removed. Next, the second selection unit 2105 sorts the first selected motion vectors (3,1)_{S}, (3,0)_{S}, (3,-1)_{R}, and (2,0)_{T} by importance. The second selection unit 2105 assigns priorities to the first selected motion vectors (3,1)_{S}, (3,0)_{S}, (3,-1)_{R}, and (2,0)_{T} according to importance of these motion vectors themselves, and then sorts the first selected motion vectors (3,1)_{S}, (3,0)_{S}, (3,-1)_{R}, and (2,0)_{T} according to the assigned priorities. If, in this example, the randomly generated motion vector (3,-1)_{R} is most important while a temporal motion vector is least important then the first selected motion vectors after sorting may be in an order as follows: (3,-1)_{R}, (3,1)_{S}, (3,0)_{S}, (2,0)_{T}. Considering the computation resources, the second selection unit 2105 may take the motion vectors (3,-1)_{R}, (3,1)_{S}, and (3,0)_{S} as the second selected motion vectors and output the second selected motion vectors to the decision unit 2110. Next, the decision unit 2110 determines a target motion vector corresponding to a minimum difference among these corresponding block matching costs. By doing this, the motion estimation apparatus 200 can efficiently determine a preferred motion vector for an image block without consuming the majority of the computation resources. In other words, through the operation of the motion estimation apparatus 200, a time for selecting preferred reference motion vectors will become short, and a battery of a mobile device in which the motion estimation apparatus 200 is applied will not be wasted. Of course, if the computation resources are very limited, the second selection unit 2105 may take only two motion vectors (3,-1)_{R} and (3,1)_{S} as the second selected motion vectors and output the second selected motion vectors to the decision unit 2110. Thus, the decision unit 2110 takes only the motion vectors (3,-1)_{R} and (3,1)_{S} for calculating respective block matching costs and then determines a target motion vector. The number of motion vectors which are used for calculating corresponding block matching costs can be determined dynamically according to conditions of the computation resources (e.g. bandwidth, power, battery, data rate, etc). In this example, under the same condition of achieving almost identical video quality, the motion estimation apparatus 200 generally only needs 30%-50% of the original computation resources.

Of course, the priorities of the first selected motion vectors corresponding to the top, left, right, bottom image blocks shown in FIG. 3 can be modified to be higher than those corresponding to the top-left, top-right, bottom-left, bottom-right image blocks. Additionally, it is not a limitation of the present invention that the determined motion vectors described above should correspond to image blocks adjacent to a current image block (as shown in FIG. 3), so priorities of first selected motion vectors in another example can be determined in accordance with the distances between a current image block and respective image blocks corresponding to the first selected motion vectors themselves. For instance, the priority of a first selected motion vector corresponding to a further image block is lower than that of another first selected motion vector associated with a nearer image block.

In another embodiment, the second selection unit 2105 is an optional unit element. In other words, the decision device 210 in this situation does not choose second selected motion vectors from a plurality of first selected motion vectors according to priorities of the second selected motion vectors but refers to the first selected motion vectors directly for determining a target motion vector. Since the decision device 210 determines the target motion vector without referring to each non-selected motion vector remaining in the candidate motion vectors, the computation resources can be saved to a certain degree. Moreover, in other embodiments, selecting a set of motion vectors from a group of motion vectors according to priorities of the group of motion vectors can be performed before selecting a set of motion vectors from a group of motion vectors according to dissimilarity of the group of motion vectors. This modification also falls within the scope of the present invention.

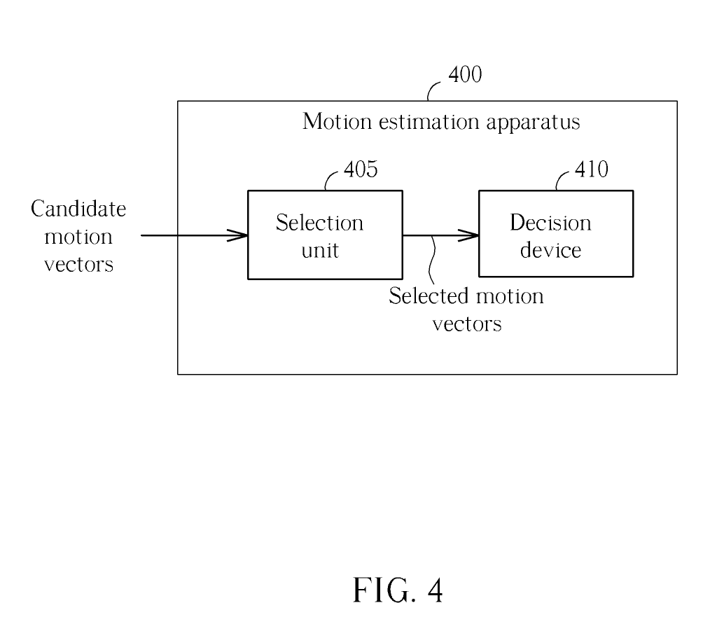

Furthermore, even if only the step of selecting a set of motion vectors from candidate motion vectors according to priorities of the candidate motion vectors is performed, the computation resources will still be saved to some degree. Please refer to FIG. 4. FIG. 4 is a block diagram illustrating a motion estimation apparatus 400 according to a second embodiment of the present invention. The motion estimation apparatus 400 includes a selection unit 405 and a decision device 410. The selection unit 405 selects a plurality of selected motion vectors from a plurality of candidate motion vectors by referring to priorities of the candidate motion vectors. The decision device 410 then determines a target motion vector corresponding to a minimum block matching cost according to the selected motion vectors, without referring to each non-selected motion vector remaining in the candidate motion vectors. A number of the selected motion vectors can be determined according to computation resources; further description is not detailed for brevity.

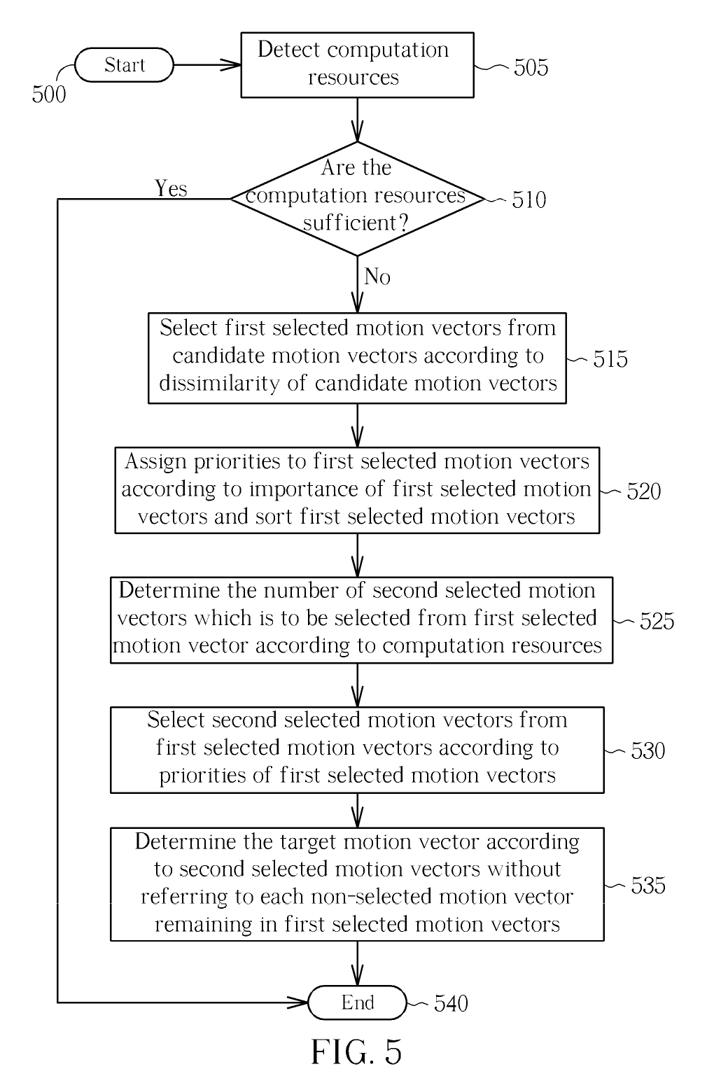

Finally, in order to describe the spirit of the present invention more clearly, a flowchart of the motion estimation apparatus 200 shown in FIG. 2 is illustrated in FIG. 5; the steps are detailed as follows:
Step 500: Start;
Step 505: Detect the computation resources;
Step 510: Are the computation resources sufficient? If so, go to Step 540; otherwise, go to Step 515;
Step 515: Select the first selected motion vectors from the candidate motion vectors according to dissimilarity of the candidate motion vectors;
Step 520: Assign priorities to the first selected motion vectors according to importance of the first selected motion vectors and sort the first selected motion vectors;
Step 525: Determine the number of second selected motion vectors which are to be selected from the first selected motion vectors according to the computation resource;
Step 530: Select the second selected motion vectors from the first selected motion vectors according to priorities of the first selected motion vectors;
Step 535: Determine the target motion vector according to the second selected motion vectors without referring to each non-selected motion vector remaining in the first selected motion vectors;
Step 540: End.
   Those skilled in the art will readily observe that numerous modifications and alterations of the device and method may be made while retaining the teachings of the invention.

What is claimed is:

1. A motion estimation method, comprising:
selecting a plurality of first selected motion vectors from a plurality of candidate motion vectors according to dissimilarity of the candidate motion vectors; and
determining a target motion vector corresponding to a minimum block matching cost according to the first selected motion vectors without referring to each non-selected motion vector remaining in the candidate motion vectors.

2. The motion estimation method of claim 1, wherein the first selected motion vectors are dissimilar to each other; and the step of selecting the first selected motion vectors comprises:
when a difference between two of the candidate motion vectors is less than a threshold value, selecting one motion vector from the two of the candidate motion vectors as one of the first selected motion vectors.

3. The motion estimation method of claim 1, wherein the step of determining the target motion vector corresponding to the minimum block matching cost according to the first selected motion vectors comprises:
selecting a plurality of second selected motion vectors from the first selected motion vectors according to priorities of the first selected motion vectors; and
determining the target motion vector corresponding to the minimum block matching cost according to the second selected motion vectors without referring to each non-selected motion vector remaining in the first selected motion vectors.

4. The motion estimation method of claim 3, wherein a number of the second selected motion vectors is determined according to computation resources.

5. The motion estimation method of claim 1, wherein the candidate motion vectors are determined according to a three-dimensional recursive search (3DRS) algorithm.

6. A motion estimation method, comprising:
selecting a plurality of selected motion vectors from a plurality of candidate motion vectors according to priorities of the candidate motion vectors; and
determining a target motion vector corresponding to a minimum block matching cost according to the selected motion vectors without referring to each non-selected motion vector remaining in the candidate motion vectors.

7. The motion estimation method of claim 6, wherein a number of the selected motion vectors is determined according to computation resources.

8. The motion estimation method of claim 6, wherein the candidate motion vectors are determined according to a three-dimensional recursive search (3DRS) algorithm.

9. A motion estimation apparatus, comprising:
a first selection unit, for selecting a plurality of first selected motion vectors from a plurality of candidate motion vectors according to dissimilarity of the candidate motion vectors; and
a decision device, coupled to the first selection unit, for determining a target motion vector corresponding to a minimum block matching cost according to the first selected motion vectors without referring to each non-selected motion vector remaining in the candidate motion vectors.

10. The motion estimation apparatus of claim 9, wherein the first selected motion vectors are dissimilar to each other; and the selection unit selects one motion vector from the candidate motion vectors as one of the selected motion vectors when a difference between two of the candidate motion vectors is less than a threshold value.

11. The motion estimation apparatus of claim 9, wherein the decision device comprises:
a second selection unit, for selecting a plurality of second selected motion vectors from the first selected motion vectors according to priorities of the first selected motion vectors; and
a decision unit, coupled to the second selection unit, for determining the target motion vector corresponding to the minimum block matching cost according to the second selected motion vectors without referring to each non-selected motion vector remaining in the first selected motion vectors.

12. The motion estimation apparatus of claim 11, wherein a number of the second selected motion vectors is determined according to computation resources.

13. The motion estimation apparatus of claim 9, wherein the candidate motion vectors are determined according to a three-dimensional recursive search (3DRS) algorithm.

14. A motion estimation apparatus, comprising:
a selection unit, for selecting a plurality of selected motion vectors from a plurality of candidate motion vectors according to priorities of the candidate motion vectors; and
a decision device, coupled to the selection unit, for determining a target motion vector corresponding to a minimum block matching cost according to the selected motion vectors without referring to each non-selected motion vector remaining in the candidate motion vectors.

15. The motion estimation apparatus of claim 14, wherein a number of the selected motion vectors is determined according to computation resources.

16. The motion estimation apparatus of claim 14, wherein the candidate motion vectors are determined according to a three-dimensional recursive search (3DRS) algorithm.
